(19) United States
(12) Patent Application Publication
(10) Pub. No.: US 2010/0306725 A1
(43) Pub. Date: Dec. 2, 2010

(54) APPARATUS AND METHOD FOR DESIGNING SEMICONDUCTOR INTEGRATED CIRCUIT, AND COMPUTER READABLE MEDIUM

(75) Inventor: Yukio KAWASAKI, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/724,251

(22) Filed: Mar. 15, 2010

(30) Foreign Application Priority Data
May 27, 2009 (JP) 2009-127468

(51) Int. Cl. G06F 17/50

(52) U.S. Cl. 716/10

(57) ABSTRACT

An apparatus for designing a semiconductor integrated circuit according to an embodiment of the present invention includes an interface circuit information extracting unit configured to specify one or more transmitting registers and one or more receiving registers forming an interface that needs to be synchronized, an insertion point candidate specifying unit configured to specify a number of supply sources that is of a number of the transmitting registers serving as data supply sources, for each receiving register, and specify at least one insertion point candidate based on the number of supply sources, an insertion point specifying unit configured to specify a number of output destinations that is of a number of the receiving registers serving as data output destinations, for each transmitting register, and specify at least one insertion point based on the number of output destinations and the insertion point candidate, and a synchronization circuit inserting unit configured to insert a synchronization circuit in the insertion point, and generate synchronized circuit description data of the semiconductor integrated circuit in which the synchronization circuit is inserted in the insertion point.

### CROSS REFERENCE TO RELATED APPLICATION

This application is based upon and claims the benefit of priority from the prior Japanese Patent Application No. 2009-127468, filed on May 27, 2009, the entire contents of which are incorporated herein by reference.

### BACKGROUND OF THE INVENTION

1. Field of the Invention

The present invention relates to an apparatus and a method for designing a semiconductor integrated circuit, and a computer readable medium, for example, for automatically inserting and optimizing a synchronization circuit.

2. Background Art

According to an SoC (System on Chip) design, many functional blocks which are individually designed are incorporated on one chip. Therefore, an LSI (Large Scale Integration) of the SoC design generally includes many clock domains. In designing such an LSI, a designer manually makes a synchronization required to transfer data between different clock domains.

In the LSI having plural clock domains, when the data is to be transferred between clock domains having different clock frequencies, it is necessary to insert a synchronization circuit in a clock domain boundary for dealing with a metastability. However, sometimes a data-reception-side clock domain is provided with a logic circuit that receives output signals from plural synchronization circuits. In the plural output signals sent to the logic circuit, sometimes one-cycle timing difference is generated between the signals by an output timing difference between the synchronization circuits. The timing difference possibly causes a malfunction of the logic circuit. Such a problem with the malfunction is called a reconvergence problem. There is a strong demand for a technique for dealing with the metastability while the reconvergence problem is avoided.

A well known technique against the reconvergence problem is to add a gray encoder/decoder circuit or an FIFO circuit to the LSI. However, the technique causes problems that a circuit size of the LSI and a designer resource for designing the LSI increase due to the addition of the circuit.

For example, JP-A 2006-252438 (KOKAI) discloses a detection support apparatus configured to detect, based on logic circuit description information to be checked and two or more registers in one clock domain of a pair of clock domains, a reconvergence register that converges in the other clock domain. According to the detection support apparatus disclosed in JP-A 2006-252438 (KOKAI), a process for checking an operation of a reconvergence circuit can be made efficient under an assumption that there exists the reconvergence circuit.

### SUMMARY OF THE INVENTION

An aspect of the present invention is, for example, an apparatus for designing a semiconductor integrated circuit, the apparatus including an interface circuit information extracting unit configured to specify one or more transmitting registers and one or more receiving registers forming an interface that needs to be synchronized, from circuit description data of the semiconductor integrated circuit, clock domain information that is of information on a clock domain of the semiconductor integrated circuit, and unsynchronized point information indicating one or more unsynchronized points in the semiconductor integrated circuit, and extract interface circuit information that is of circuit connection information between the transmitting registers and the receiving registers, an insertion point candidate specifying unit configured to specify a number of supply sources that is of a number of the transmitting registers serving as data supply sources, for each receiving register from the interface circuit information, specify at least one insertion point candidate that is of a candidate of a point in which a synchronization circuit is to be inserted, based on the number of supply sources, and generate insertion point candidate information indicating the insertion point candidate, an insertion point specifying unit configured to specify a number of output destinations that is of a number of the receiving registers serving as data output destinations, for each transmitting register, specify at least one insertion point to which the synchronization circuit is to be inserted, based on the number of output destinations and the insertion point candidate information, and generate insertion point information indicating the insertion point, and a synchronization circuit inserting unit configured to insert the synchronization circuit in the insertion point by using the insertion point information and circuit description data of the synchronization circuit, and generate synchronized circuit description data of the semiconductor integrated circuit in which the synchronization circuit is inserted in the insertion point.

Another aspect of the present invention is, for example, a method for designing a semiconductor integrated circuit, the method including specifying one or more transmitting registers and one or more receiving registers forming an interface that needs to be synchronized, from circuit description data of the semiconductor integrated circuit, clock domain information that is of information on a clock domain of the semiconductor integrated circuit, and unsynchronized point information indicating one or more unsynchronized points in the semiconductor integrated circuit, and extracting interface circuit information that is of circuit connection information between the transmitting registers and the receiving registers, specifying a number of supply sources that is of a number of the transmitting registers serving as data supply sources, for each receiving register from the interface circuit information, specifying at least one insertion point candidate that is of a candidate of a point in which a synchronization circuit is to be inserted, based on the number of supply sources, and generating insertion point candidate information indicating the insertion point candidate, specifying a number of output destinations that is of a number of the receiving registers serving as data output destinations, for each transmitting register, specifying at least one insertion point to which the synchronization circuit is to be inserted, based on the number of output destinations and the insertion point candidate information, and generating insertion point information indicating the insertion point, and inserting the synchronization circuit in the insertion point by using the insertion point information and circuit description data of the synchronization circuit, and generating synchronized circuit description data of the semiconductor integrated circuit in which the synchronization circuit is inserted in the insertion point.

Another aspect of the present invention is, for example, a computer readable medium storing a computer program for making a computer to perform a method for designing a semiconductor integrated circuit, the method including specifying one or more transmitting registers and one or more receiving registers forming an interface that needs to be synchronized, from circuit description data of the semiconductor integrated circuit, clock domain information that is of information on a clock domain of the semiconductor integrated circuit, and unsynchronized point information indicating one or more unsynchronized points in the semiconductor integrated circuit, and extracting interface circuit information that is of circuit connection information between the transmitting registers and the receiving registers, specifying a number of supply sources that is of a number of the transmitting registers serving as data supply sources, for each receiving register from the interface circuit information, specifying at least one insertion point candidate that is of a candidate of a point in which a synchronization circuit is to be inserted, based on the number of supply sources, and generating insertion point candidate information indicating the insertion point candidate, specifying a number of output destinations that is of a number of the receiving registers serving as data output destinations, for each transmitting register, specifying at least one insertion point to which the synchronization circuit is to be inserted, based on the number of output destinations and the insertion point candidate information, and generating insertion point information indicating the insertion point, and inserting the synchronization circuit in the insertion point by using the insertion point information and circuit description data of the synchronization circuit, and generating synchronized circuit description data of the semiconductor integrated circuit in which the synchronization circuit is inserted in the insertion point.

### BRIEF DESCRIPTION OF THE DRAWINGS

FIG. 1 is a block diagram illustrating a configuration of an LSI design apparatus according to an embodiment of the present invention;

FIG. 2 is a circuit diagram illustrating the processing performed by an interface circuit information extracting unit;

FIG. 3 is a circuit diagram illustrating the processing performed by an insertion point candidate specifying unit;

FIG. 4 is a circuit diagram illustrating the processing performed by an insertion point specifying unit; and

FIG. 5 is a circuit diagram illustrating the processing performed by a synchronization circuit inserting unit.

### DESCRIPTION OF THE EMBODIMENTS

Embodiments of the present invention will be described with reference to the drawings.

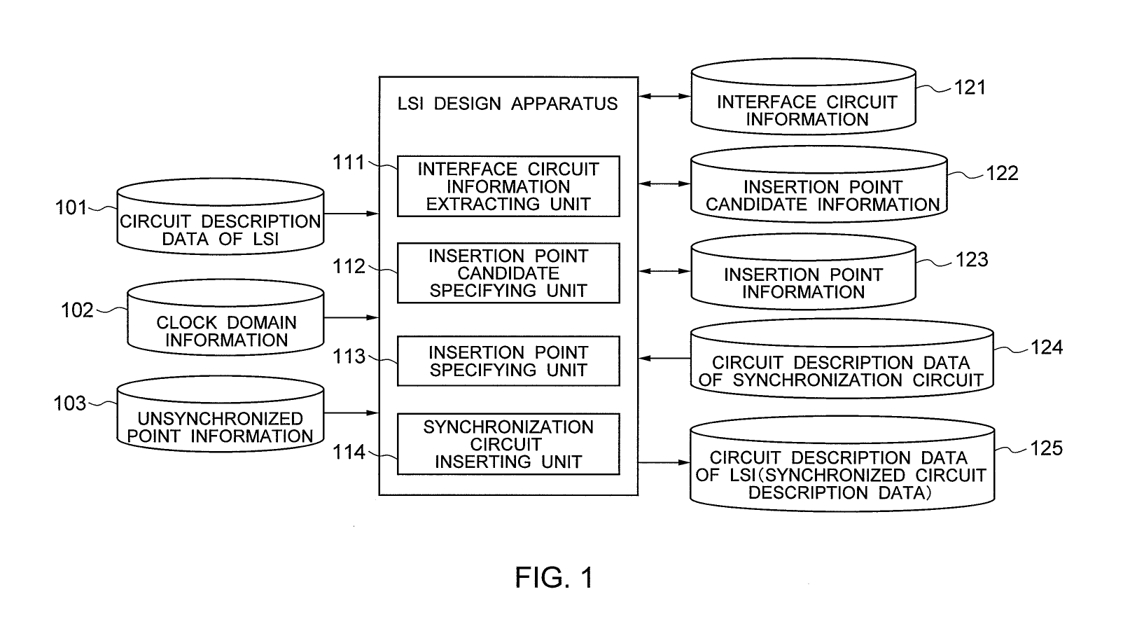

FIG. 1 is a block diagram illustrating a configuration of an LSI design apparatus according to an embodiment of the present invention. The LSI design apparatus of FIG. 1 is an example of an apparatus for designing a semiconductor integrated circuit according to the present invention.

The LSI design apparatus of FIG. 1 is supplied with circuit description data 101 of an LSI to be synchronized, i.e., to be applied a synchronization design. For example, the circuit description data 101 is of circuit description data described at a register transfer level.

The LSI design apparatus of FIG. 1 is further supplied with clock domain information 102 described by a designer. The clock domain information 102 is of information on clock domains of the LSI. Examples of the clock domain information 102 include an external clock terminal name, a terminal name of a circuit serving as a clock supply source such as a PLL (Phase Locked Loop), and a clock domain name as an identifier for distinguishing between a synchronization and an unsynchronization.

The LSI design apparatus of FIG. 1 is further supplied with unsynchronized point information 103. The unsynchronized point information 103 is of information indicating one or more unsynchronized points in the LSI, i.e., one or more points on which the synchronization is not made yet. Examples of the unsynchronized point information 103 include names of registers between which the synchronization is not made, and a name of an interconnection between registers to which the synchronization is not made.

The LSI design apparatus of FIG. 1 includes an interface circuit information extracting unit 111, an insertion point candidate specifying unit 112, an insertion point specifying unit 113, and a synchronization circuit inserting unit 114.

The interface circuit information extracting unit 111 analyzes the clock domains included in the LSI by using the circuit description data 101, the clock domain information 102, and the unsynchronized point information 103, and specifies an interface that needs to be synchronized from interfaces between different clock domains. The interface circuit information extracting unit 111 specifies an interface to which the synchronization is not made as the interface that needs to be synchronized, from the circuit description data 101, the clock domain information 102, and the unsynchronized point information 103.

More specifically, the interface circuit information extracting unit 111 specifies one or more transmitting registers and one or more receiving registers which forms the interface. Each of the transmitting registers transmits data to another circuit forming the interface. Each of the receiving registers receives data from another circuit forming the interface.

The interface circuit information extracting unit 111 analyzes circuit connection information that is of information on a connection relationship between circuits in the LSI, based on a result of specifying the transmitting registers and the receiving registers. Consequently, interface circuit information 121 that is of information on the circuit connection between the specified transmitting registers and receiving registers is extracted. As illustrated in FIG. 1, the extracted interface circuit information 121 is stored in a database for the interface circuit information 121.

The insertion point candidate specifying unit 112 specifies a Fan-In number for each receiving register from the interface circuit information 121. The Fan-In number is of a number of the transmitting registers serving as data supply sources of a receiving register. The Fan-Out number is an example of a number of supply sources of the present invention.

The insertion point candidate specifying unit 112 specifies at least one insertion point candidate that is of a candidate of a point at which the synchronization circuit is inserted based on the specified Fan-In number, and generates insertion point candidate information 122 indicating the insertion point candidate. As illustrated in FIG. 1, the generated insertion point candidate information 122 is stored in a database for the insertion point candidate information 122.

The insertion point specifying unit 113 specifies a Fan-Out number for each transmitting register. The Fan-Out number is of a number of the receiving registers serving as data output destinations of a transmitting register. The Fan-Out number is an example of a number of output destinations of the present invention.

The insertion point specifying unit 113 specifies at least one insertion point that is of a point at which the synchronization circuit is inserted based on the specified Fan-Out number and the insertion point candidate information 122, and generates insertion point information 123 indicating the insertion point. In other words, the insertion point specifying unit 113 reviews the at least one insertion point candidate, and reduces the number of the candidate by deleting a part of the at least one insertion point candidate. As illustrated in FIG. 1, the generated insertion point information 123 is stored in a database for the insertion point information 123.

The synchronization circuit inserting unit 114 inserts the synchronization circuit in the insertion point by using the insertion point information 123 and previously-prepared circuit description data 124 of the synchronization circuit.

Consequently, the synchronization circuit inserting unit 114 generates synchronized circuit description data 125 of the LSI in which the synchronization circuit is inserted in the insertion point, from the circuit description data 101 of the LSI. As illustrated in FIG. 1, the generated circuit description data 125 is stored in a database for the circuit description data 125.

Hereinafter, processing performed by the interface circuit information extracting unit 111, the insertion point candidate specifying unit 112, the insertion point specifying unit 113, and the synchronization circuit inserting unit 114 will be described in detail.

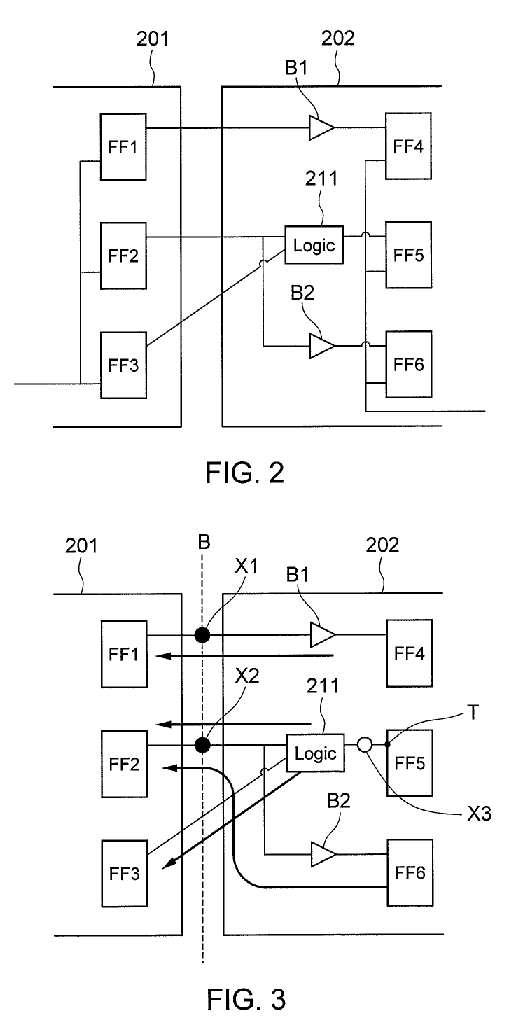

FIG. 2 is a circuit diagram illustrating the processing performed by the interface circuit information extracting unit 111.

As described above, the interface circuit information extracting unit 111 specifies the transmitting registers and the receiving registers forming the interface that is necessary to be synchronized, from the circuit description data 101, the clock domain information 102, and the unsynchronized point information 103.

FIG. 2 illustrates an example of the interface that needs to be synchronized. FIG. 2 is a circuit diagram illustrating a configuration of the LSI. FIG. 2 illustrates the interface between a first clock domain 201 and a second clock domain 202, which have different clock frequencies.

FIG. 2 also illustrates transmitting registers FF1 to FF3 in the first clock domain 201 and receiving registers FF4 to FF6 in the second clock domain 202 as the registers forming the interface. Each of the transmitting registers transmits data to another circuit forming the interface, and each of the receiving registers receives data from another circuit forming the interface. In FIG. 2, these registers are flip-flop circuits. FIG. 2 also illustrates buffer circuits B1 and B2 in the second clock domain 202 and a logic circuit 211 as the circuits forming the interface.

FIG. 2 also illustrates a connection relationship among the transmitting registers FF1 to FF3, the receiving registers FF4 to FF6, the buffer circuits B1 and B2, and the logic circuit 211. The connection relationship among them is extracted from the circuit connection information that is of information on a connection relationship between circuits in the LSI, and is stored as the interface circuit information 121 in the database.

According to the processing performed by the interface circuit information extracting unit 111, the transmitting registers FF1 to FF3 and the receiving registers FF4 to FF6 of FIG. 2 are specified from the circuit description data 101, the clock domain information 102, and the unsynchronized point information 103 to extract the interface circuit information 121 on the circuit (interface circuit) of FIG. 2.

The processing performed by the interface circuit information extracting unit 111 will be described with reference to FIG. 2.

First, if the circuit description data 101, the clock domain information 102, and the unsynchronized point information 103 is inputted by a designer, the interface circuit information extracting unit 111 specifies a clock domain of each register in the LSI. For example, the interface circuit information extracting unit 111 backtraces a clock connection path from a clock terminal of each register to an external terminal or a terminal of a black box circuit such as a PLL. Then, the interface circuit information extracting unit 111 specifies a clock domain name of the clock domain to which each register belongs by comparing a reached external terminal name or a reached terminal name of the black box circuit to the clock domain information 102 provided by the designer. Then, the interface circuit information extracting unit 111 gives the specified clock domain name to each register.

Next, the interface circuit information extracting unit 111 extracts the circuit connection information on the register-register connection relationship from the circuit description data 101, and compares the pieces of the clock domain information on a pair of registers for which the circuit connection information is extracted. When the registers have the different clock domain names, the interface circuit information extracting unit 111 refers to the unsynchronized point information 103 provided by the designer. Then, the interface circuit information extracting unit 111 specifies whether the synchronization is made between the registers, from the names of the registers or the name of the interconnection between the registers.

When the synchronization is not made between the registers, the interface circuit information extracting unit 111 extracts a connection path between the registers in order to make the registers to be synchronized.

Similarly, the interface circuit information extracting unit 111 specifies points at which synchronizations are not made yet, at a boundary between the different clock domains. Consequently, the transmitting registers FF1 to FF3 and the receiving registers FF4 to FF6 of FIG. 2 are specified to extract the interface circuit information 121 on the interface circuit of FIG. 2, for example. The extracted interface circuit information 121 is stored in the database.

FIG. 3 is a circuit diagram illustrating the processing performed by the insertion point candidate specifying unit 112. Similarly to FIG. 2, FIG. 3 is a circuit diagram illustrating a configuration of the LSI.

First, the insertion point candidate specifying unit 112 specifies the Fan-In number of each receiving register from the interface circuit information 121. The Fan-In number is the number of the transmitting registers serving as the data supply sources. For example, the register FF4 is supplied with data only from the register FF1, and the register FF6 is supplied with data only from the register FF2, so that Fan-In numbers of the registers FF4 and FF6 are “1”. On the other hand, the register FF5 is supplied with data from the registers FF2 and FF3, so that the Fan-In number of the register FF5 is “2”. For example, the insertion point candidate specifying unit 112 backtraces a circuit connection path from a data input terminal of each receiving register to data output terminals of the transmitting registers, and specifies the Fan-In number of each receiving register from a number of data output terminals of the reached transmitting registers.

Next, the insertion point candidate specifying unit 112 specifies at least one insertion point candidate for inserting the synchronization circuit such that the reconvergence problem can be avoided, based on the specified Fan-In number. In FIG. 3, the logic circuit 211 receives the output signals from the transmitting registers FF2 and FF3. If the synchronization circuit is inserted in the clock domain boundary like a conventional manner, sometimes one-cycle timing difference is generated between the output signals, and the timing difference possibly causes a malfunction of the logic circuit 211. In other words, the reconvergence problem is possibly generated in the logic circuit 211.

Therefore, the insertion point candidate specifying unit 112 determines that a receiving register having the Fan-In number of 2 or more is a point at which the reconvergence problem is generated. The insertion point candidate specifying unit 112 adopts, for the receiving register having the Fan-In number of 2 or more, a net connected to a data input terminal of the receiving register, as the insertion point candidate. In FIG. 3, the letter T designates the data input terminal of the register FF5, and the numeral X3 designates the insertion point candidate adopted for the register FF5.

On the other hand, the insertion point candidate specifying unit 112 determines that the reconvergence problem is not generated in a receiving register having the Fan-In number of 1. The insertion point candidate specifying unit 112 adopts, for the receiving register having the Fan-In number of 1, a net on the boundary located upstream of the receiving register, as the insertion point candidate as with the normal synchronization. In FIG. 3, the letter B designates the clock domain boundary, and the numerals X1 and X2 designate the insertion point candidates adopted for the registers FF4 and FF6, respectively.

Then, the insertion point candidate specifying unit 112 generates the insertion point candidate information 122 that is of the information indicating the insertion point candidate, and stores the generated insertion point candidate information 122 in the database.

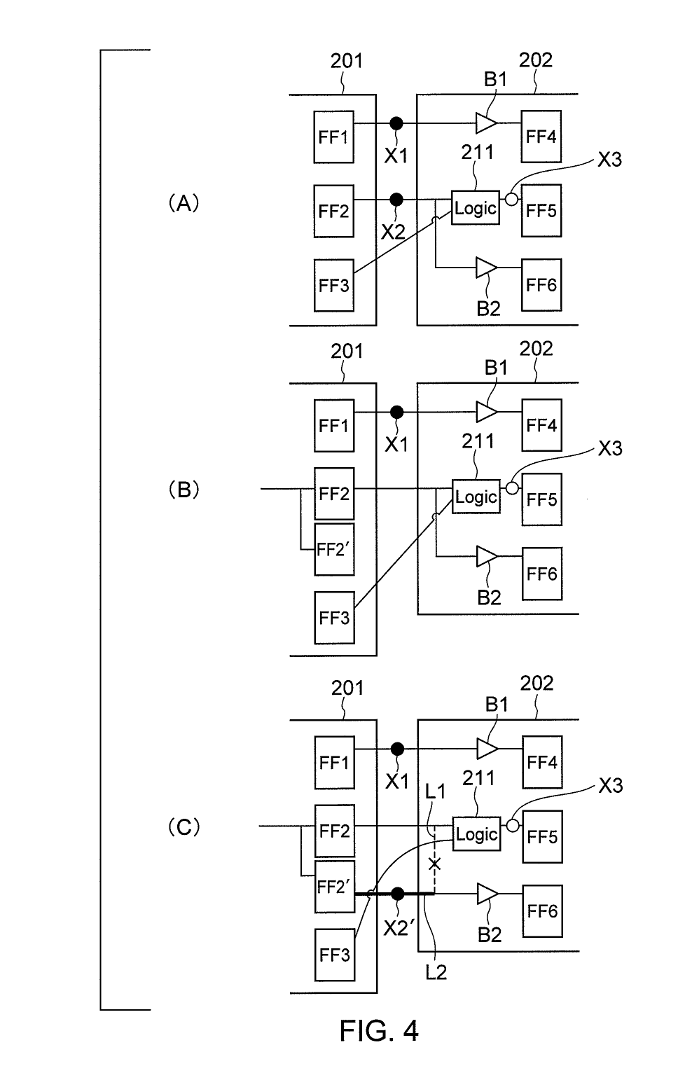

FIG. 4 is a circuit diagram illustrating the processing performed by the insertion point specifying unit 113. Similarly to FIG. 2, each of FIGS. 4(A) to 4(C) is a circuit diagram illustrating a configuration of the LSI.

First, the insertion point specifying unit 113 specifies the Fan-Out number of each transmitting register. The Fan-Out number is the number of the receiving registers serving as the data output destinations. For example, as illustrated in FIG. 4(A), the register FF1 supplies data only to the register FF4, and the register FF3 supplies data only to the register FF5, so that the Fan-In numbers of the registers FF1 and FF3 are “1”. On the other hand, the register FF2 supplies data to the registers FF5 and FF6, so that the Fan-Out number of the register FF5 is “2”.

The insertion point specifying unit 113 may specify the Fan-Out number of each transmitting register from the insertion point candidate information 122 or from the interface circuit information 121. In the former case, for example, the insertion point specifying unit 113 specifies the Fan-Out number of each transmitting register by using a result of the backtrace performed by the insertion point candidate specifying unit 112. The result of the backtrace is included in the insertion point candidate information 122. On the other hand, in the latter case, for example, the insertion point specifying unit 113 trances a circuit connection path from a data output terminal of each transmitting register to the data input terminals of the receiving registers, and specifies the Fan-Out number of each transmitting register form a number of data input terminals of the reached receiving register.

Next, the insertion point specifying unit 113 specifies at least one insertion point for inserting the synchronization circuit such that one insertion point exists on a path between any one transmitting register and any one receiving register, based on the specified Fan-Out number and the insertion point candidate information 122.

For example, as illustrated in FIG. 4(A), since the register FF2 has the Fan-Out number of 2, two insertion point candidates X2 and X3 exist on the path between the registers FF2 and FF5. In such a case, the insertion point specifying unit 113 determines that the insertion point candidate X3 which is determined in consideration of the reconvergence problem cannot be deleted, and determines that the remaining insertion point candidate X2 is redundant. As a result, the insertion point specifying unit 113 adopts the insertion point candidate X3 as the insertion point, and deletes the insertion point candidate X2.

On the other hand, as illustrated in FIG. 4(A), since the register FF1 has the Fan-Out number of 1, one insertion point candidate X1 exists on the path between the registers FF1 and FF4. In such a case, the insertion point specifying unit 113 adopts the insertion point candidate X1 as the insertion point.

In this way, the insertion point specifying unit 113 adopts, for a transmitting register having the Fan-Out number of 2 or more, a part of insertion point candidates located downstream of the transmitting register as the insertion point, and deletes a remaining part of the insertion point candidates located downstream of the transmitting register. On the other hand, the insertion point specifying unit 113 directly adopts, for a transmitting register having the Fan-Out number of 1, an insertion point candidate located downstream of the transmitting register as the insertion point.

In FIG. 4(A), the insertion point disappears on the path between the registers FF2 and FF6 by deleting the insertion point candidate X2. In other words, the synchronization is not made on the path between the registers FF2 and FF6. Therefore, in order to avoid such situation, the insertion point specifying unit 113 performs cloning processing and interconnection changing processing such that the Fan-Out number of the register FF2 becomes 1.

First, as illustrated in FIG. 4(B), the insertion point specifying unit 113 performs cloning of a transmitting register having the Fan-Out number of 2 or more. FIG. 4(B) illustrates the state in which the register FF2 is cloned to generate a register FF2′ that is a clone of the register FF2. The register FF2′ is supplied with the clock identical to that supplied to the register FF2.

Next, as illustrated in FIG. 4(C), the insertion point specifying unit 113 performs the interconnection changing processing for changing an interconnection of a path between the transmitting register and the receiving register on which the insertion point does not exist. FIG. 4(C) illustrates the state in which an interconnection L1 forming the path between the registers FF2 and FF6 is deleted and an interconnection L2 connecting the registers FF2′ and FF6 is provided instead. Consequently, the connection between the registers FF2 and FF6 is eliminated, and the registers FF2′ and FF6 are connected instead.

Next, the insertion point specifying unit 113 re-specifies at least one insertion point, after the cloning processing and the interconnection changing processing. For example, the re-specification of the insertion point is performed by the processing similar to the insertion point candidate specifying processing performed by the insertion point candidate specifying unit 112. FIG. 4(C) illustrates an insertion point X2′ that is adopted for the register FF2′ by the re-specification of the insertion point. The insertion point X2′ exists on a net on the clock domain boundary located upstream of the register FF6. In this way, the insertion point specifying unit 113 optimizes the insertion point through the cloning and the interconnection changing processing.

Then, the insertion point specifying unit 113 generates the insertion point information 123 that is of information indicating the insertion point, and stores the generated insertion point information 123 in the database.

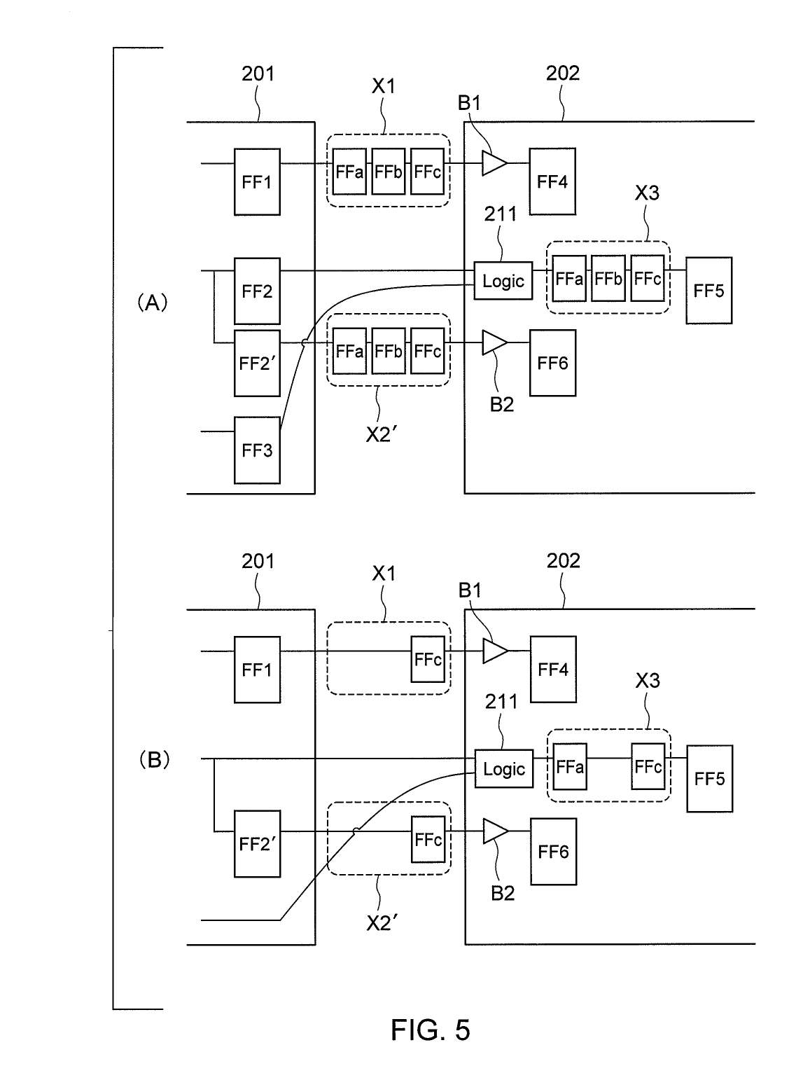

FIG. 5 is a circuit diagram illustrating the processing performed by the synchronization circuit inserting unit 114. Similarly to FIG. 2, each of FIGS. 5(A) and 5(B) is a circuit diagram illustrating a configuration of the LSI.

As illustrated in FIG. 5(A), the synchronization circuit inserting unit 114 inserts the synchronization circuit in the insertion point by using the insertion point information 123, and the circuit description data 124 of the synchronization circuit which is prepared by the designer. In FIG. 5(A), three series-connected registers FFa, FFb, and FFc are inserted as the synchronization circuit in each of the insertion points X1, X2′, and X3. The register FFa is a flipflop circuit operated by a clock (transmission-side clock) in the first clock domain 201, and the registers FFb and FFc are flipflop circuits operated by a clock (reception-side clock) in the second clock domain 202.

In this way, the synchronization circuit in this embodiment is a multi-flop type. In this embodiment, the circuit description data 124 of the synchronization circuit including the registers FFa, FFb, and FFc is prepared by the designer. The synchronization circuit is not limited to the configuration including the three registers. For example, the synchronization circuit may have a configuration including plural series-connected registers except for the three series-connected registers.

Next, the synchronization circuit inserting unit 114 performs redundant circuit deletion processing for deleting at least one redundant register in the registers of FIG. 5(A). In other words, at least one redundant register is deleted from the transmitting registers FF1 to FF3, the receiving registers FF4 to FF6, the register FF2′ generated by the cloning, and the registers FFa to FFc inserted in the insertion points X1, X2′, and X3.

In general, one synchronizing register operated by the transmission-side clock and two registers operated by the reception-side clock need to be disposed on any path that passes through the boundary between the clock domains having the different clock frequencies. In this case, other registers existing on the path is determined to be the redundant registers. In this embodiment, the synchronization circuit inserting unit 114 deletes the redundant register by such a criterion.

The redundant circuit deletion processing performed by the synchronization circuit inserting unit 114 will be described below with reference to FIGS. 5(A) and 5(B).

As illustrated in FIG. 5(A), the registers FF1 and FFa that operate by the transmission-side clock and the registers FFb, FFc, and FF4 that operate by the reception-side clock exist on the path between the registers FF1 and FF4. Therefore, the synchronization circuit inserting unit 114 deletes one of the registers FF1 and FFa and one of the registers FFb, FFc, and FF4. In this embodiment, as illustrated in FIG. 5(B), the registers FFa and FFb are deleted on this path.

As illustrated in FIG. 5(A), the registers FF2′ and FFa that operate by the transmission-side clock and the registers FFb, FFc, and FF6 that operate by the reception-side clock exist on the path between the registers FF2′ and FF6. Therefore, the synchronization circuit inserting unit 114 deletes one of the registers FF2′ and FFa and one of the registers FFb, FFc, and FF6. In this embodiment, as illustrated in FIG. 5(B), the registers FFa and FFb are deleted on this path.

As illustrated in FIG. 5(A), the registers FF2 and FFa that operate by the transmission-side clock and the registers FFb, FFc, and FF5 that operate by the reception-side clock exist on the path between the registers FF2 and FF5. Similarly, the registers FF3 and FFa that operate by the transmission-side clock and the registers FFb, FFc, and FF5 that operate by the reception-side clock exist on the path between the registers FF3 and FF5.

Therefore, with respect to the registers that operate by the transmission-side clock, the synchronization circuit inserting unit 114 deletes a pair of registers FF2 and FF3 or the register FFa from these paths. On the other hand, for the registers that operate by the reception-side clock, the synchronization circuit inserting unit 114 deletes one of the registers FFb, FFc, and FF5 from these paths.

However, if the register FFa is deleted from the paths, the logic circuit 211 is located between the register that operates by the transmission-side clock and the register that operates by the reception-side clock. This means that the logic circuit 211 is located on the boundary between the clock domains. In general, such a disposition of the logic circuit 211 is frequently determined to be a design infringement in making the LSI design. Therefore, in this embodiment, the synchronization circuit inserting unit 114 deals with such a disposition of the logic circuit 211 as the design infringement, and does not permit the register FFa to be deleted from the paths.

Therefore, as illustrated in FIG. 5(B), the registers FF2 and FF3 are deleted from the paths for the registers that operate by the transmission-side clock. Further, as illustrated in FIG. 5(B), the register FFb is deleted from the paths for the registers that operate by the reception-side clock. However, the register FFc or FF5 may be deleted instead of the register FFb from the paths for the registers that operate by the reception-side clock.

In this way, the synchronization circuit inserting unit 114 generates the synchronized circuit description data 125 of the LSI including the interface circuit of FIG. 5(B), and the generated circuit description data 125 is stored in the database.

As described above, the LSI design apparatus of this embodiment specifies the Fan-In number of each receiving register, specifies the insertion point candidate based on the Fan-In number, specifies the Fan-Out number of each transmitting register, specifies the insertion point based on the Fan-Out number and the insertion point candidate information, and makes the synchronization by using the insertion point information. Consequently, in this embodiment, the metastability can be dealt with while the reconvergence problem is avoided.

Further, in this embodiment, since the insertion and optimization of the synchronization circuit are automated through the above-described processing, the synchronization that is needed to connect the different clock domains can be made while loads by the designer are suppressed. In this embodiment, the circuit optimized as the synchronization circuit can be obtained.

Further, the LSI design apparatus of this embodiment specifies the transmitting registers and the receiving registers forming the interface that needs to be synchronized, from the circuit description data 101, the clock domain information 102, and the unsynchronized point information 103, and extracts the interface circuit information 121 on the interface. Consequently, in this embodiment, the Fan-In number and the Fan-Out number can automatically be specified.

The processing performed by the interface circuit information extracting unit 111, the insertion point candidate specifying unit 112, the insertion point specifying unit 113, and the synchronization circuit inserting unit 114 can be realized by a computer program for making a computer to perform the processing, for example. The computer program is stored, for example, in a computer readable medium such as a CD-ROM, a DVD, a semiconductor memory, and a magnetic memory.

As described above, the embodiment of the present invention can provide the apparatus and the method for designing the semiconductor integrated circuit and the computer readable medium that can deal with the metastability while avoiding the reconvergence problem.

Although examples of specific aspects of the present invention are described above with reference to the embodiment of the present invention, the present invention is not limited to the embodiment.

1. An apparatus for designing a semiconductor integrated circuit, the apparatus comprising:
an interface circuit information extracting module configured to determine at least one register in an interface to be synchronized, the at least one register comprising at least one transmitting register and at least one receiving register with (data can't be a singular) circuit description data of the semiconductor integrated circuit, clock domain information of the semiconductor integrated circuit, and unsynchronized point information indicating at least one unsynchronized points in the semiconductor integrated circuit, and to extract interface circuit information associated with the connection between the transmitting registers and the receiving registers;
an insertion point candidate selector configured to determine a number of supply sources equal to a number of the transmitting registers serving as data supply sources, for each receiving register from the interface circuit information, to select at least one insertion point candidate configured to couple to a synchronization circuit based on the number of supply sources, and to generate insertion point candidate information indicating the insertion point candidate;
an insertion point selector configured to determine a number of output destinations equal to a number of the receiving registers serving as data output destinations for each transmitting register, to select at least one insertion point configured to couple to the synchronization circuit, based on the number of output destinations and the insertion point candidate information, and to generate insertion point information indicating the insertion point; and
a synchronization circuit editor configured to insert the synchronization circuit in the insertion point based on the insertion point information and circuit description data of the synchronization circuit, and to generate synchronized circuit description data of the semiconductor integrated circuit comprising the synchronization circuit coupled with the insertion point.

2. The apparatus of claim 1, wherein
the interface circuit information extracting module is configured to extract a clock domain name of each register in the semiconductor integrated circuit, to compare clock domain names of registers in the semiconductor integrated circuit, to determine whether a plurality of registers associated with a plurality of clock domain names, respectively, are synchronized, and to define registers out of synchronization as a transmitting register and a receiving register forming the interface.

3. The apparatus of claim 2, wherein
the interface circuit information extracting module is configured to determine a clock domain name of each register by backtracing a clock connection path from a clock terminal of each register.

4. The apparatus of claim 1, wherein
the insertion point candidate selector is configured to select a net on a clock domain boundary at an upstream side of the receiving register as the insertion point candidate for a receiving register comprising one supply source, and
the insertion point candidate selector is configured to select a net connected to a data input terminal of the receiving register as the intersection point candidate for a receiving register comprising two or more supply sources.

5. The apparatus of claim 1, wherein
the insertion point candidate selector is configured to backtrace a circuit connection path from a data input terminal of each receiving register to data output terminals of the transmitting registers, and to determine the number of supply sources of each receiving register based on a number of data output terminals of reached transmitting registers.

6. The apparatus of claim 1, wherein
the insertion point selector is configured to select an insertion point candidate at a downstream side of the transmitting register as the insertion point for a transmitting register comprising one output destination, and
the insertion point selector is configured to select a portion of insertion point candidates at a downstream side of the transmitting register as the insertion point, and to delete remaining the insertion point candidates at a downstream side of the transmitting register for a transmitting register comprising two or more output destinations.

7. The apparatus of claim 1, wherein
the insertion point selector is configured to determine the number of output destinations from the interface circuit information.

8. The apparatus of claim 7, wherein
the insertion point selector is configured to trace a circuit connection path from a data output terminal of each transmitting register to data input terminals of the receiving registers based on the interface circuit information, and to determine the number of output destinations of each transmitting register based on a number of data input terminals of reached receiving registers.

9. The apparatus of claim 1, wherein
the insertion point selector is configured to determine the number of output destinations from the insertion point candidate information.

10. The apparatus of claim 9, wherein
the insertion point selector is configured to determine the number of output destinations from a result of a backtrace.

11. The apparatus of claim 1, wherein
the insertion point selector is configured to select the at least one insertion point on a path between a transmitting register and a receiving register.

12. The apparatus of claim 6, wherein
the insertion point selector is configured to clone a transmitting register or a receiving register, and to change an interconnection between a transmitting register and a receiving register, when the remaining insertion point candidates are deleted, and
the insertion point selector is configured to re-select at least one insertion point after the cloning and the interconnection change.

13. The apparatus of claim 1, wherein
the synchronization circuit editor is configured to delete a redundant register in the transmitting registers, the receiving registers, and the synchronization circuit, after the synchronization circuit is inserted.

14. The apparatus of claim 13, wherein
the synchronization circuit editor is configured to delete a logic circuit in the semiconductor integrated circuit on a boundary between clock domains.

15. The apparatus of claim 13, wherein
the synchronization circuit editor is configured to delete one register operated by a transmission-side clock and two registers operated by a reception-side clock on any path through a boundary between a plurality of clock domains associated with a plurality of clock frequencies respectively.

16. The apparatus of claim 1, wherein
the circuit description data of the semiconductor integrated circuit is described at a register transfer level.

17. The apparatus of claim 1, wherein
the clock domain information comprises an external clock terminal name, a terminal name of a circuit serving as a clock supply source, or a clock domain name.

18. The apparatus of claim 1, wherein
the unsynchronized point information comprises names of registers out of synchronization, or a name of an interconnection between registers without the synchronization circuit.

19. A method for designing a semiconductor integrated circuit, the method comprising:
determining at least one transmitting register and at least one receiving register in an interface to be synchronized with circuit description data of the semiconductor integrated circuit, clock domain information of the semiconductor integrated circuit, and unsynchronized point information indicating at least one unsynchronized point in the semiconductor integrated circuit;
extracting interface circuit information associated with the connection between the transmitting registers and the receiving registers;
determining a number of supply sources equal to a number of the transmitting registers serving as data supply sources, for each receiving register from the interface circuit information;
selecting at least one insertion point candidate configured to couple to a synchronization circuit based on the number of supply sources;
generating insertion point candidate information indicating the insertion point candidate;
determining a number of output destinations equal to a number of the receiving registers serving as data output destinations, for each transmitting register;
selecting at least one insertion point configured to couple to the synchronization circuit, based on the number of output destinations and the insertion point candidate information;
generating insertion point information indicating the insertion point;
inserting the synchronization circuit in the insertion point based on the insertion point information and circuit description data of the synchronization circuit; and
generating synchronized circuit description data of the semiconductor integrated circuit comprising the synchronization circuit coupled with the insertion point.

20. A computer readable medium having stored thereon a computer program for designing a semiconductor integrated circuit, that when executed by the computer, causes the computer to:
determine at least one transmitting register and at least one receiving register in an interface to be synchronized, with circuit description data of the semiconductor integrated circuit, clock domain information of the semiconductor integrated circuit, and unsynchronized point information indicating at least one unsynchronized point in the semiconductor integrated circuit;
extract interface circuit information associated with the connection between the transmitting registers and the receiving registers;
determine a number of supply sources equal to a number of the transmitting registers serving as data supply sources, for each receiving register from the interface circuit information;
select at least one insertion point candidate configured to couple to a synchronization circuit based on the number of supply sources;
generate insertion point candidate information indicating the insertion point candidate;
determine a number of output destinations equal to of a number of the receiving registers serving as data output destinations, for each transmitting register;
select at least one insertion point configured to couple to the synchronization circuit, based on the number of output destinations and the insertion point candidate information;
generate insertion point information indicating the insertion point;
insert the synchronization circuit in the insertion point based on the insertion point information and circuit description data of the synchronization circuit; and
generate synchronized circuit description data of the semiconductor integrated circuit comprising the synchronization circuit coupled with the insertion point.
